(19) United States
(12) Patent Application Publication
(10) Pub. No.: US 2009/0056452 A1
(43) Pub. Date: Mar. 5, 2009

(54) ACOUSTIC WAVE SENSOR SYSTEM

(75) Inventor: James ZT Liu, Belvidere, IL (US)

Correspondence Address: Bryan Anderson, Attorney, Intellectual Property;Honeywell International Inc., 101 Columbia Rd., P.O. Box 2245, Morristown, NJ, 07962, US

(73) Assignee: Honeywell International Inc.

(21) Appl. No.: 12/248,623

(22) Filed: Oct. 9, 2008

Related U.S. Application Data
(63) Continuation-in-part of application No. 11/334,989, filed on Jan. 18, 2006.

(51) Int. Cl. G01N 29/036

(52) U.S. Cl. 73/579

(57) ABSTRACT

An acoustic wave sensor can be used to sense a liquid's properties such as temperature, corrosivity, density, and viscosity. Degraded measurements result when changes in one property are confused with changes in a different property. A rigid coating can minimize amount of measurement degradation due to viscosity changes in the liquid. A visco-elastic-interaction curve can be used to find the ideal thickness of the rigid coating, called the constant Q thickness. A visco-elastic-interaction curve relates the sensor Q to rigid coating thickness for a specific combination of sensor, liquid, and coating material.

### RELATED PATENT APPLICATIONS

This application is a Continuation-In-Part (CIP) under 25 U.S.C. § 120 of U.S. patent application Ser. No. 11/334,989, filed on Jan. 18, 2006.

### TECHNICAL FIELD

Embodiments relate to acoustic wave sensors and sensor systems. Embodiments also relate to using acoustic wave sensors to measure physical properties of liquids.

### BACKGROUND OF THE INVENTION

Acoustic wave sensors are often used to measure the physical properties of liquids such as temperature, density viscosity, and corrosivity. Those practiced in the art of acoustic wave sensors know of many different types of acoustic wave sensors including bulk acoustic wave (BAW) sensors and surface acoustic wave (SAW) sensors.

FIG. 5, labeled as “prior art”, illustrates one type of SAW sensor 501. A first transducer 504 and second transducer 503 are patterned on a piezoelectric substrate 502. An interrogation signal can be passed to the first transducer 504 which converts the interrogation signal into an acoustic wave. The acoustic wave travels through the piezoelectric substrate 502 to the second transducer 503 where it is converted into an output signal. The interrogation signal can be an electrical signal that passes through wired electrical connections. Alternatively, the interrogation signal can be an electromagnetic wave that passes wirelessly through the air. The output signal can also be an electrical signal or an electromagnetic wave.

Those practiced in the art of acoustic wave devices know of many materials that can be used as piezoelectric substrates. Some of those materials are quartz, lithium niobate (LiNbO₃), lithium tantalite (LiTaO₃), Li₂B₄O₇, GaPO₄, langasite (La₃Ga₅SiO₁₄), ZnO, and epitaxially grown nitrides such as those of Aluminum, Gallium, and Indium.

An acoustic wave sensor has a fundamental frequency at which it responds strongly to an interrogation signal. An interrogation circuit can pass an interrogation signal having a known frequency to the sensor which oscillates in response. The sensor oscillations can then be observed by the interrogation circuit. Changes to the sensor's environment can cause changes to the sensor's fundamental frequency. Measurements of the fundamental frequency can therefore yield measurements of the sensor's environment. For example, increasing a sensor's temperature can cause the fundamental frequency to increase. Exposing the sensor to a corrosive liquid can also cause the fundamental frequency to increase. Similarly, exposing the sensor to a liquid and then increasing the liquid's density can cause the fundamental frequency to increase. It can be difficult to produce a meaningful measurement when more than one environmental factor is changing.

FIG. 6, labeled as “prior art”, illustrates a change in frequency response when a sensor is exposed to a viscous liquid. When exposed to a liquid having a low viscosity, the sensor responds strongly as indicated by the first response curve 602. Raising the liquid viscosity, however, reduces the sensor response as indicated by the second response curve 603. The response curves indicate how strongly the sensor responds to interrogation signals having different frequencies. The first curve 602 shows that the sensor has a larger response when the liquid has lower viscosity.

Sensor measurement accuracy can be significantly degraded when many environmental factors change. For example, an acoustic sensor measuring a liquid's temperature can produce spurious results when density or viscosity change while temperature remains constant. Current technology requires the use of multiple sensors producing many different measurements. Mathematical analysis of the different measurements can isolate one environmental factor from the others so that an accurate measurement can be made.

Another approach that has been used to produce less degraded measurements is to use a coating to protect the acoustic wave sensor from corrosion. As discussed above, corrosion can cause the fundamental frequency to increase. A problem occurs when a temperature sensor shows a slowly increasing temperature when, in reality, the temperature is constant but the sensor is corroding. Coating the sensor with a material that resists corrosion solves the problem. For example, hydrophobic coating materials repel water while hydrophilic coating materials do not. Tantalum, Silicon Carbide, and Silicon Dioxide can be used as coating materials. Carbon can be used as a coating material in either diamond, buckyball, or nanotube form. Fluorinated polymers such as Teflon can also be used as coating materials.

Aspects of the embodiments directly address the shortcoming of current technology by characterizing the acoustic sensor, liquid, coating material, and coating thickness to avoid measurement degradations due to viscosity variations.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments to provide an acoustic wave device. Bulk acoustic wave type devices typically have one transducer on the substrate's front surface and another transducer on the substrate's back surface. Surface acoustic wave type devices typically have two transducers on the substrate's front surface although some variations have only a single transducer that is on the substrates front surface.

It is also an aspect of the embodiments that a rigid coating is on the front side. The rigid coating can be created using a deposition process or an epitaxy process. The thickness of the rigid coating is equal to or greater than a constant Q thickness. The constant Q thickness can be determined from a visco-elastic-interaction curve. The visco-elastic-interaction curve relates the sensor Q to rigid coating thickness for a specific combination of sensor, liquid, and coating material. For example, the sensor can be a specific model of surface acoustic wave based device produced by a manufacturer, the rigid coating can be Teflon, and the liquid can be a grade of motor oil.

A number of materials can be used for the rigid coating. Some of those materials are Tantalum, Silicon Carbide, and Silicon Dioxide. Carbon can be used as a coating material in many of its forms such as diamond, buckyball, or nanotube. Fluorinated polymers such as Teflon can also be used as coating materials.

A number of materials can be used as a piezoelectric substrate. Some of those materials are quartz, lithium niobate (LiNbO3), lithium tantalite (LiTaO3), Li2B4O7, GaPO4, langasite (La3Ga5SiO14), ZnO, and epitaxially grown nitrides such as those of Aluminum, Gallium, and Indium.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a constant Q bulk acoustic wave sensor with a rigid coating in accordance with aspects of the embodiments;

FIG. 2 illustrates a visco-elastic-interaction curve in accordance with aspects of the embodiments;

FIG. 3 illustrates a constant Q acoustic wave sensor exposed to a liquid in accordance with aspects of the embodiments;

FIG. 4 illustrates frequency response curves for coated and uncoated sensors in accordance with aspects of the embodiments;

FIG. 5, labeled as “prior art”, illustrates a surface acoustic wave device;

FIG. 6, labeled as “prior art”, illustrates a change in frequency response when a sensor is exposed to a viscous liquid; and

FIG. 7 illustrates a high level flow diagram of creating a constant Q sensor in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

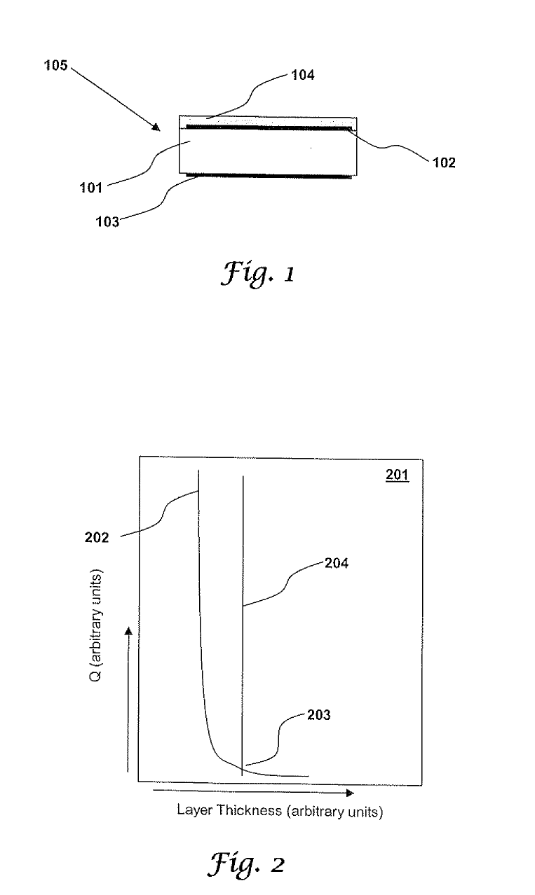

FIG. 1 illustrates a constant Q bulk acoustic wave sensor 105 with a rigid coating in accordance with aspects of the embodiments. A piezoelectric substrate 101 has a first transducer 102 on the front side and a second transducer 103 on the back side. A rigid coating 104 has been deposited on the front side of the piezoelectric substrate 101 and over the first transducer 102. The rigid coating thickness is equal to or greater then the constant Q thickness. The constant Q thickness depends on the sensor, the rigid coating thickness, and the liquid to which the sensor is exposed.

FIG. 2 illustrates a visco-elastic-interaction graph 201 in accordance with aspects of the embodiments. The visco-elastic-interaction graph 201 relates sensor Q, also called the quality factor, to layer thickness when an acoustic wave sensor is exposed to a liquid. Layer thickness is the thickness of the rigid coating. A visco-elastic-interaction curve 203 can be generated for a specific combination of acoustic wave device, coating material, and liquid. As can be seen, there is a knee 203 in the curve. Q changes rapidly for thicknesses below the knee and slowly for thickness greater than the knee. The thickness at the knee is the constant Q thickness 204 because Q is nearly constant when the rigid coating is thicker than the constant Q thicknesses 204. Those skilled in the arts of sensors, amplifiers, or resonant systems are familiar with Q. Those skilled in the art of measuring the properties of liquids are familiar with the effect of a liquid's viscosity on acoustic wave sensor Q.

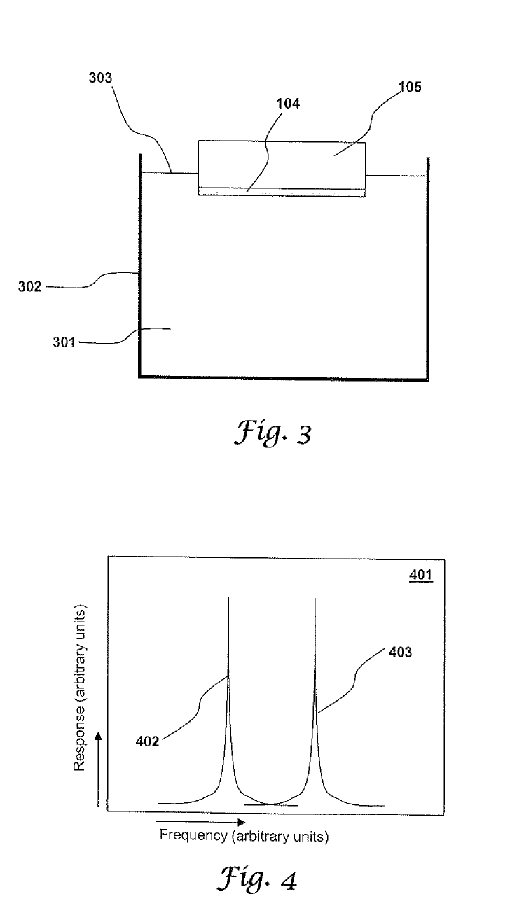

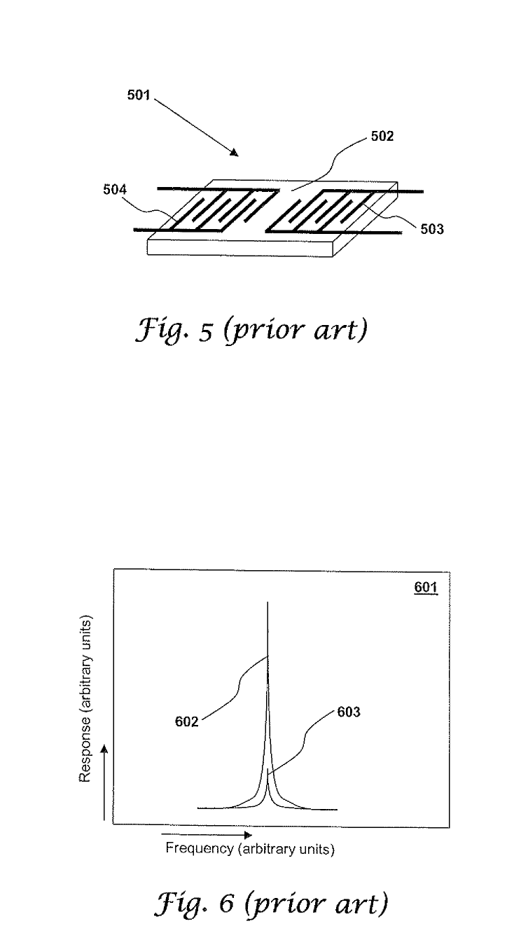

FIG. 3 illustrates a constant Q acoustic wave sensor 105 exposed to a liquid 301 in accordance with aspects of the embodiments. The constant Q acoustic wave sensor 105 has a rigid coating 104 on the front side. A container 302 holds a liquid 301. The constant Q acoustic wave sensor 105 is exposed to the liquid 301 by dipping it into the liquid and thereby exposing the rigid coating 104 to the liquid 301. Here, only one side of the sensor is exposed. In other embodiments, the entire sensor can be exposed. If the entire sensor is exposed, then both the front and back of the sensor should be coated with a rigid coating. The thicknesses of both the front coating and back coating should be equal to or greater than the constant Q thickness.

FIG. 4 illustrates frequency response curves for coated and uncoated sensors in accordance with aspects of the embodiments. The graph 401 shows two curves. The uncoated curve 402 and the coated curve 403 show the sensor response as a function of interrogation signal frequency. As can be seen, applying a rigid coating to an acoustic wave sensor can cause the response curve to shift so that the maximum response occurs at a higher frequency. The strength of the response, however, does not change significantly.

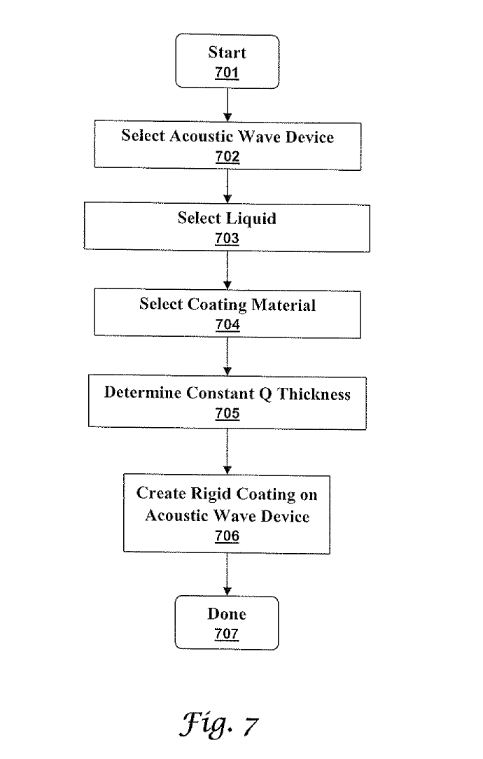

FIG. 7 illustrates a high level flow diagram of creating a constant Q sensor in accordance with aspects of the embodiments. After the start 701 an acoustic wave device is selected 702, a liquid is selected 703, and a coating material is selected 704. The coating material can be selected based on its interaction with the liquid. For example, a material that quickly dissolves in the liquid is a bad choice. Having selected a specific sensor, liquid, and coating material, the constant Q thickness is determined 705. One way to find the constant Q thickness is to use a visco-elastic-interaction curve. Another way is to simply look it up in a database or specification sheet. Next, the rigid coating is created on the acoustic wave device 706 to yield a constant Q acoustic wave device. Finally, the process is done 707.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

What is claimed is:

1. A system comprising:
an acoustic wave device comprising a piezoelectric substrate, a first transducer, and a second transducer wherein the acoustic wave device has a front side and wherein the first transducer is on the front side;
a rigid coating adhering to the front side; and
a liquid wherein the rigid coating is exposed to the liquid, wherein a visco-elastic-interaction curve is determined by the acoustic wave device, the rigid coating, and the liquid, wherein the a visco-elastic-interaction curve has a constant Q thickness, and wherein the thickness of the rigid coating is equal to or greater than the constant Q thickness.

2. The system of claim 1 wherein the rigid coating is hydrophobic.

3. The system of claim 1 wherein the rigid coating a hydrophilic.

4. The system of claim 1 wherein the rigid coating comprises tantalum.

5. The system of claim 1 wherein the rigid coating comprises carbon.

6. The system of claim 1 wherein the rigid coating comprises a fluorinated polymer.

7. The system of claim 1 wherein the rigid coating comprises Silicon Carbide.

8. The system of claim 1 wherein the rigid coating comprises Silicon Dioxide.

9. A system comprising;
a bulk acoustic wave device comprising a piezoelectric substrate, a first transducer, and a second transducer wherein the acoustic wave device has a front side and wherein the first transducer is on the front side;
a rigid coating adhering to the front side; and
a liquid wherein the rigid coating is exposed to the liquid, wherein a visco-elastic-interaction curve is determined by the acoustic wave device, the rigid coating, and the liquid, wherein the a visco-elastic-interaction curve has a constant Q thickness, and wherein the thickness of the rigid coating is equal to or greater than the constant Q thickness.

10. The system of claim 9 wherein the rigid coating is hydrophobic.

11. The system of claim 9 wherein the rigid coating a hydrophilic.

12. The system of claim 9 wherein the rigid coating comprises tantalum.

13. The system of claim 9 wherein the rigid coating comprises carbon.

14. The system of claim 9 wherein the rigid coating comprises fluorinated polymer.

15. The system of claim 9 wherein the rigid coating comprises Silicon Carbide.

16. The system of claim 9 wherein the rigid coating comprises Silicon Dioxide.

17. A method comprising:
selecting an acoustic wave device, a liquid, and a coating material;
determining a constant Q thickness using a visco-elastic-interaction curve based on the acoustic wave device, the coating material, and the liquid;
creating a rigid coating on the acoustic wave device wherein the rigid coating comprises the coating material and wherein the rigid coating is at least as thick as the constant Q thickness thereby producing a constant Q acoustic wave device.

18. The system of claim 17 wherein the rigid coating is hydrophobic.

19. The system of claim 17 wherein the rigid coating a hydrophilic.

20. The system of claim 17 wherein the piezoelectric substrate is quartz.
